(19) United States
(12) Patent Application Publication
(10) Pub. No.: US 2016/0129759 A1
(43) Pub. Date: May 12, 2016

(54) Air Extractor Grille

(71) Applicant: Ford Global Technologies, LLC, Dearborn, MI (US)

(72) Inventors: Eric R. Yerke, Redford, MI (US); Paul Bryan Hoke, Plymouth, MI (US); Frank Fusco, Plymouth, MI (US); Robert Steven Sawyer, Farmington Hills, MI (US)

(21) Appl. No.: 14/538,893

(22) Filed: Nov. 12, 2014

(51) Int. Cl. B60H 1/24

(52) U.S. Cl. CPC B60H 1/248

(57) ABSTRACT

An air extractor vent is disclosed for a vehicle. A package tray defines an opening adjacent the lower edge of a rear window. A grille is assembled to the air extraction opening. The grille includes vanes for directing air away from the rear window and for obscuring the lines of sight from inside and outside of the vehicle through the air extraction opening.

### TECHNICAL FIELD

This disclosure relates to a grille for an air extractor that vents air from a passenger compartment of a vehicle to improve air flow within the passenger compartment.

### BACKGROUND

Air extractors are currently provided in the passenger compartment to enhance airflow inside the vehicle. Poor air flow can cause window fogging if moist air is not drawn away from the inner surface of the window glass. Air extractors also vent air from the passenger compartment to reduce the force required to close the doors of the vehicle.

Currently available air extractors include holes or perforations in the package tray (a panel that extends from the top of rear seatback to the lower edge of a rear window). Air extraction holes in the package tray create sight lines from outside the rear window and inside the vehicle to sheet metal and structural components beneath the package tray. To eliminate objectionable sight lines, the holes may be covered by textile covering materials that block the airflow through the air extractors. Blocking air flow through the extractors may exacerbate window fogging problems and increase the effort required to close the doors of the vehicle.

This disclosure is directed to solving the above problems and other problems as summarized below.

### SUMMARY

An air extractor is disclosed for a package tray including a fixed vane grille that covers air extractor openings in the package tray. The grille has curved vanes that extend transversely across the vehicle. The vanes have an upper edge that is closest to the rear window glass and a lower edge that is forward of the upper edge. The orientation of the vanes is intended to block sight lines from inside and outside the vehicle to the vehicle structure below the package tray. The vanes are also located and oriented to draw heavier moist air away from the rear window glass and out of the passenger compartment.

According to one aspect of this disclosure, an air extractor vent is disclosed for a vehicle having a rear window disposed behind a rear seatback. A package tray extends between the rear seatback and the rear window and defines at least one air extraction opening adjacent the rear window. A grille is assembled over the air extraction opening that includes vanes for directing air passing through the grille and away from the rear window.

According to another aspect of this disclosure, a grille is provided for a package tray that defines an air extraction opening adjacent a rear window of a vehicle. The grille comprises a frame extending around a perimeter of the air extraction opening and a plurality of fixed vanes. The fixed vanes are attached to the frame and extend parallel to the rear window. The vanes obstruct less than 50% of the open area of the air extraction opening.

According to other aspects of this disclosure, the vanes may be curved to more extensively block sight lines through the air extraction opening from outside the vehicle and from inside the vehicle to an area below the package tray. The vanes may have a lower edge and an upper edge disposed rearward relative to the lower edge to draw moist air from a rear edge of the rear window where the rear window meets the package tray.

The above aspects of this disclosure and other aspects will be described in greater detail below with reference to the attached drawings.

### BRIEF DESCRIPTION OF THE DRAWINGS

FIG. 1 is a perspective view of a vehicle body that includes a package tray with an air extraction apparatus with a grille made according to one embodiment of this disclosure.

FIG. 2 is a perspective view of the package tray with an air extraction apparatus and a grille made according to the embodiment of this disclosure shown in FIG. 1.

FIG. 3 is a cross-section view taken along the line 3-3 in FIG. 1.

FIG. 4 is a cross-section view of a package tray with an alternative embodiment of an air extraction apparatus with a grille.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

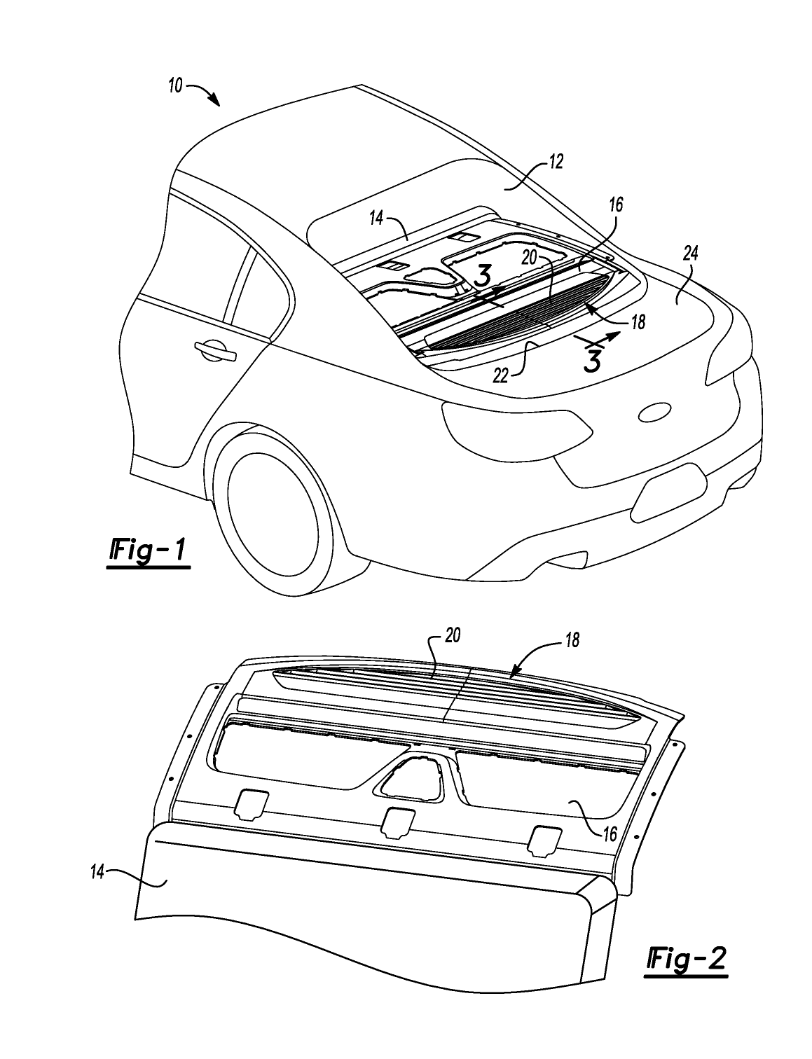

Referring to FIG. 1, a vehicle 10 is shown to include a rear window 12. A rear seatback 14 is visible inside the rear window 12. A package tray 16 extends from the rear seatback 14 rearward to the rear window 12. An air extractor vent 18 is provided on the package tray 16 that vents air from a passenger compartment 19 of the vehicle 10. A grille 20 forms part of the air extractor vent 18 and is disposed adjacent a rear edge 22 of the rear window 12. The rear edge 22 of the rear window 12 terminates near a deck lid 14 of the vehicle 10.

Referring to FIG. 2, the package tray 16 is shown to extend rearward from the rear seatback 14. The package tray 16 defines the air extractor vent 18 that is covered by the grille 20.

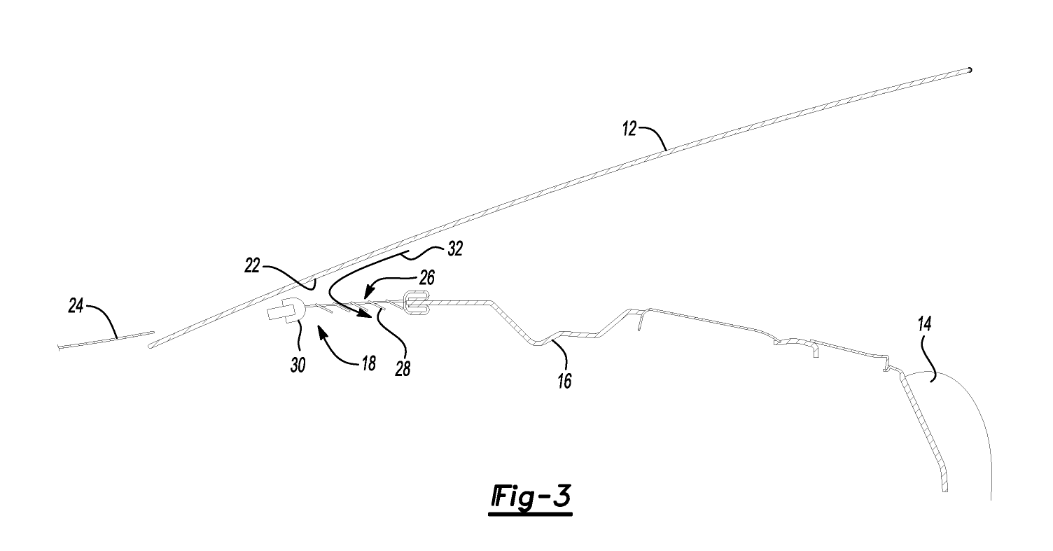

Referring to FIG. 3, the package tray 16 is shown in cross-section in an area where the package tray 16 abuts the rear window 12 at a rear edge 22 of the rear window 12. Note, the rear window, as shown, continues to the deck lid 24 and it should be understood that the rear edge 22 refers to the rear edge of the window 12 that is visible from inside the vehicle. The air extractor vent 18 includes the grille 20. The package tray 16 defines an air extraction opening 26. The grille 20 covers the air extraction opening 26. A plurality of fixed vanes 28 form the grille 20 and are fixed to a frame 30 that is attached to the package tray 16. An air flow path 32 is generally indicated by the arrow 32. Air flows along the air flow path 32 to remove moist air from the rear edge of the rear window 12 where the rear window meets the package tray 16. The fixed vanes 28 and frame 30 are preferably molded in a single piece in an injection molding process.

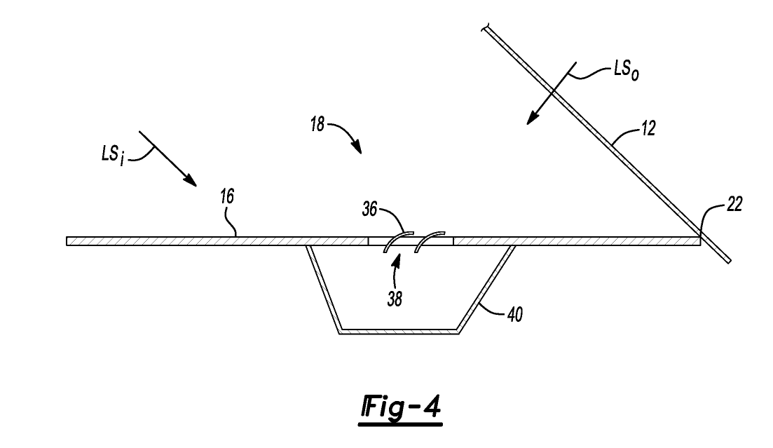

Referring to FIG. 4, an alternative embodiment is shown of the air extraction apparatus 18. In the embodiment shown in FIG. 4, a plurality of curved vanes 36 are illustrated that cover the opening 38 in the package tray 16. Vanes 28 and 36 obstruct less than 50% of the open area of the air extraction opening.

The curved vanes increase the extent to which the grille 20 blocks the line of sight through the opening 38 to body structures 40 that are disposed below the package tray 16. The line of sight from inside the vehicle 10 is indicated by the arrow LSᵢ. The arrow LSₒ indicates the line of sight from the outside of the vehicle through the rear window 12. The shape and orientation of the curved vanes 36 are more effectively block the lines of sight LSᵢ and LSₒ compared to the flat vanes 28 shown in FIG. 3.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

What is claimed is:

1. An air extractor vent for a vehicle having a rear window disposed behind a rear seatback, comprising:
a package tray extending between the rear seatback and the rear window, the package tray defining at least one air extraction opening adjacent the rear window; and
a grille assembled over the air extraction opening that includes vanes that direct air away from the rear window.

2. The air extractor vent of claim 1 wherein the vanes are curved.

3. The air extractor vent of claim 1 wherein the vanes have a lower edge and an upper edge and wherein the upper edge is disposed rearward relative to the lower edge.

4. The air extractor vent of claim 1 wherein the vanes are oriented to block sight lines through the air extraction opening from outside the vehicle to an area below the package tray.

5. The air extractor vent of claim 1 wherein the vanes are oriented to block sight lines through the air extraction opening from inside the vehicle to an area below the package tray.

6. The air extractor vent of claim 1 wherein the vanes are oriented to draw moisture in the air from a rear edge of the rear window where the rear window meets the package tray.

7. A grille for a package tray defining an air extraction opening adjacent a rear window of a vehicle, the grille comprising:
a frame extending around a perimeter of the air extraction opening; and
a plurality of fixed vanes attached to the frame and extending parallel to the rear window, wherein the vanes obstruct less than 50% of the air extraction opening.

8. The grille of claim 7 wherein the vanes are curved.

9. The grille of claim 7 wherein the vanes have a lower edge and an upper edge and wherein the upper edge is disposed rearward relative to the lower edge.

10. The grille of claim 7 wherein the vanes are oriented to block sight lines through the air extraction opening from outside the vehicle to an area below the package tray.

11. The grille of claim 7 wherein the vanes are oriented to block sight lines through the air extraction opening from inside the vehicle to an area below the package tray.

12. The grille of claim 7 wherein the vanes are oriented to draw moisture in the air from a rear edge of the rear window where the rear window meets the package tray.
